(19) United States
(12) Patent Application Publication
(10) Pub. No.: US 2002/0122247 A1
(43) Pub. Date: Sep. 5, 2002

(54) Far field dispersed microscope illumination

(76) Inventor: David C. Smith, Glastonbury, CT (US)

Correspondence Address: M.P. Williams, 210 Main Street, Manchester, CT, 06040, US

(21) Appl. No.: 09/761,324

(22) Filed: Jan. 16, 2001

(51) Int. Cl. G02B 21/18; G02B 21/06; G02B 5/08; G02B 17/00

(52) U.S. Cl. 359/385; 359/368; 359/373; 359/608

(57) ABSTRACT

An illuminated surgical microscope (17) has a phasing screen (24) with discontinuities (28a) in one surface thereof for causing phase interference that disperses the illumination sufficiently to reduce the intensity of radiation at the retina by 1000 times or even more. The phasing screen may be rotated about a pivot (44) out of the path of illumination to cause a focused spot, if desired.

### TECHNICAL FIELD

This invention relates to the introduction of spatially recurring phase change in illumination of the field of a microscope, whereby adequate intensity of the near field is achieved while interference-induced dispersion reduces the intensity in the far field by at least an order of magnitude.

### BACKGROUND ART

One example of the use of illumination which is both beneficial and harmful is in the use of an illuminated microscope in performing surgical procedures on an eye. It is believed that the eye has an optical gain of anywhere from 20,000 to 100,000; that is, the intensity of radiation entering through the iris is amplified 20,000 to 100,000 times as it is focused to a spot on the retina at the back of the eye. Therefore, light which is adequate to guide a surgeon in performing an anterior segment procedure (such as suturing a replacement cornea), without any chance of damaging the cornea or the iris, will nonetheless burn portions of the retina because of the focused, high amplification in the eye. As has been discussed in the literature, various methods have been proposed to reduce photochemical retinal damage from surgical telescopes. These measures include constricting the pupil with acetylcholine, use of ultraviolet filters (because shorter wavelengths are believed to cause more damage), simply reducing the light intensity to the minimum level that permits visualization of the surgical field, covering the cornea with a protective object when visualization along the visual axis is not required, and use of non-axial oblique illumination during suturing.

Heretofore, the movement of the light off of the visual axis of the eye, other than when centering a cornea or the like, has been done by movement of the surgical microscope platform itself, which has in some instances been shown to likely have moved the intense beam toward or at the fovea (sometimes referred to as the macula), rather than away from it. The inducement of photo toxic lesions despite use of the foregoing and other preventive measures has also been reported in the literature. Since it is probably not reasonable to expect surgical procedures to be performed within a few minutes, but permanent damage is induced in only a few minutes, reduced surgical time is not an adequate answer.

In addition, even if the damaging illumination image is kept away from the fovea, injury will still occur to some portion of the retina, thereby providing reduced visual capacity of some sort to some degree.

### DISCLOSURE OF INVENTION

Objects of the invention include provision of adequate light in the near field of a source of light so as to provide useful illumination, while at the same time avoiding high power density of such light in a high gain, focused far field; provision of microscopic illumination which is adequate for work (such as surgery) in a field of view (such as the anterior segment), without damaging (such as phototoxic lesions) surfaces removed from the field of view (such as the retina and fovea) within a focusing, high gain optical system (such as the eye); and improved illumination for microscopes. Other objects of the invention include altering the path of light from an illuminated microscope, without altering the visual axis of the microscope, whereby to remove the illuminated spot from a sensitive area (such as the fovea) and reducing the time that any part of a sensitive surface is subjected to a damaging amount of illumination, particularly the illumination of a surgical microscope that impinges upon the retina.

This invention is predicated in part on the concept that introduction of phase distortion in light from a source will induce optical distortion which defocuses the light, thereby significantly reducing its intensity in the far field, which in the case of the eye, is at the point where the cornea/lens of the eye focus images. The invention is also predicated in part on the discovery that the reduction of intensity as a result of dispersion due to phase distortion in the near field of a phase distorting element (such as at the cornea of the eye) is less than the phase distortion in the far field (such as at the image focus point on the retina of the eye).

In accord with the invention, illumination provided to the field of a microscope is dispersed by phase distortion from spatially recurring phase changes provided to the illumination; further, the recurring phase change is introduced into the illumination by means of an element (a phasing screen), at least one surface of which has a pattern therein which provides significant phase distortion to result in a high degree of dispersion of the illumination, thereby reducing the intensity of illumination significantly in the focused far field of the element.

According to the present invention, a phasing screen is introduced between a light source and the optics of an illuminated microscope (such as a surgical microscope) whereby to provide light intensity focused at a surface (such as the cornea) within high optical gain optics (such as the eye) which is reduced by on the order of 100 times, 1000 times, or more, thereby to avoid damage from the illuminating radiation (such as phototoxic lesions). According further to the invention, the phasing screen has discontinuities having a dimension parallel with the illuminating radiation which provides an adequate phase change to induce interference sufficient to disperse the light to effectively cause the desired reduction in spatial intensity in the amplified and focused far field of high gain optics (such as the eye), and a dimension normal to the radiation to provide a Fresnel number sufficiently large to assure adequate illumination at the desired working field (such as the anterior segment of an eye). The invention further provides for altering the phase change, either electronically or otherwise.

The invention is particularly well suited for use in illuminating microscopes used in medical procedures, particularly medical procedures involving eyes.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified, stylized schematic illustration of a surgical microscope employing the present invention, not to scale.

FIG. 2 is a simplified, stylized perspective view of a phasing screen for use in the microscope of FIG. 1, not to scale.

FIG. 3 is a simplified, stylized, elevation view of the lens of FIG. 2, not to scale.

### MODE(S) FOR CARRYING OUT THE INVENTION

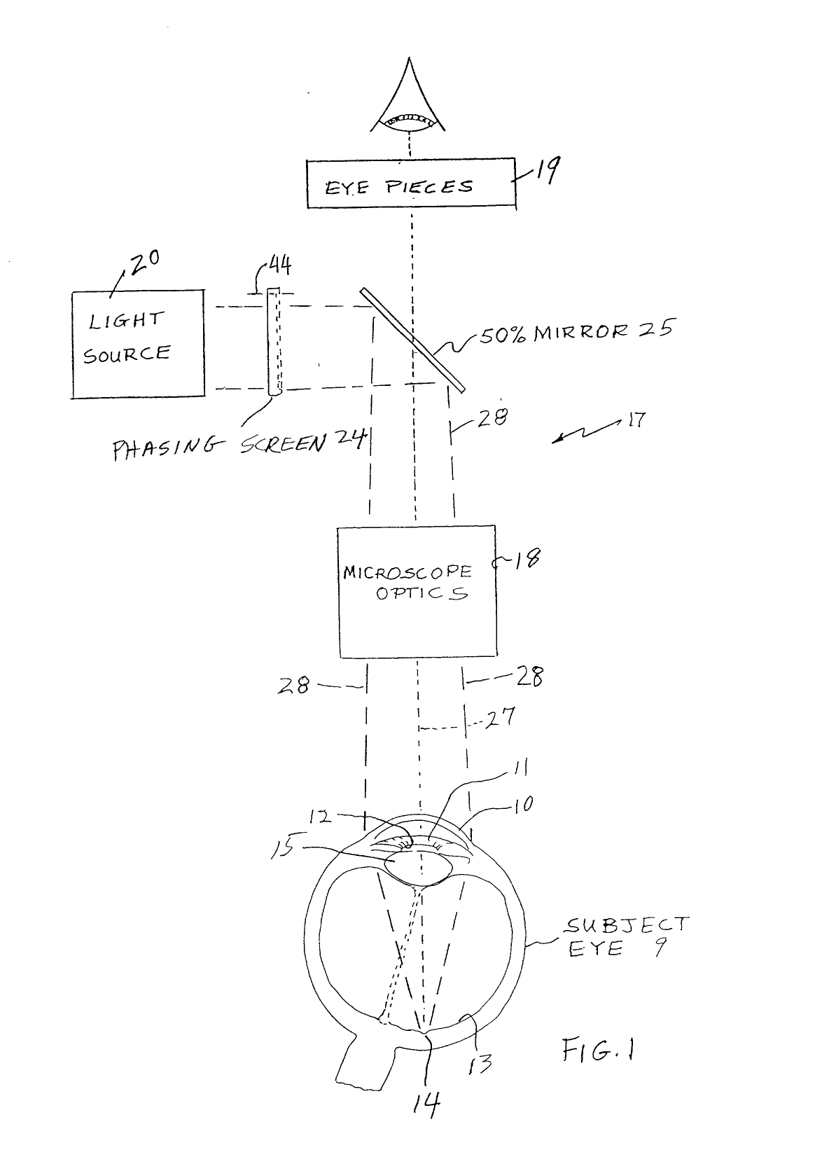

Referring to FIG. 1, an eye 9 has a cornea 10, iris 11, pupil 12, retina 13, fovea or macula 14 and a lens 15. An illuminated microscope 17, typically referred to as a surgical microscope, includes optics 18, eye pieces 19, a source of light 20, and, in accordance with the invention, a phasing screen 24 and a 50% turning/mixing mirror 25. During certain procedures, such as centering a replacement cornea before being sutured, the visual axis 27 of the microscope is aligned with the fovea 14 so as to properly center the cornea on the eye. At times other than when centering the cornea, the visual axis 27 is usually displaced from the fovea so as to avoid phototoxic lesions, which can occur in only two to several minutes due to the light of the microscope being amplified and focused by the eye.

According to the invention, the light of the microscope is depicted by dash lines 28 and is applied through a phasing screen 24 that causes adjacent portions of the propagating light to have different phases, thereby interfering and causing the light to disperse when focused. The light passing through the phasing screen 24 is turned by a 50% mirror 25 so that it is substantially coaxial with the optical axis 27 of the microscope. The beam diameter may be on the order of two centimeters (about one inch), as is conventional. Thus, the entire cornea 10 may be illuminated along with adjacent conjunctiva. Once focused by the lens 15, the typical surgical microscope provides a spot which is smaller than the fovea, with the intensity highly concentrated and amplified.

The invention depends partly on the fact that the phasing screen 24 will not disperse the light at the cornea significantly, but will provide dispersion at the retina to reduce the intensity by a factor of on the order of 1000 or even more.

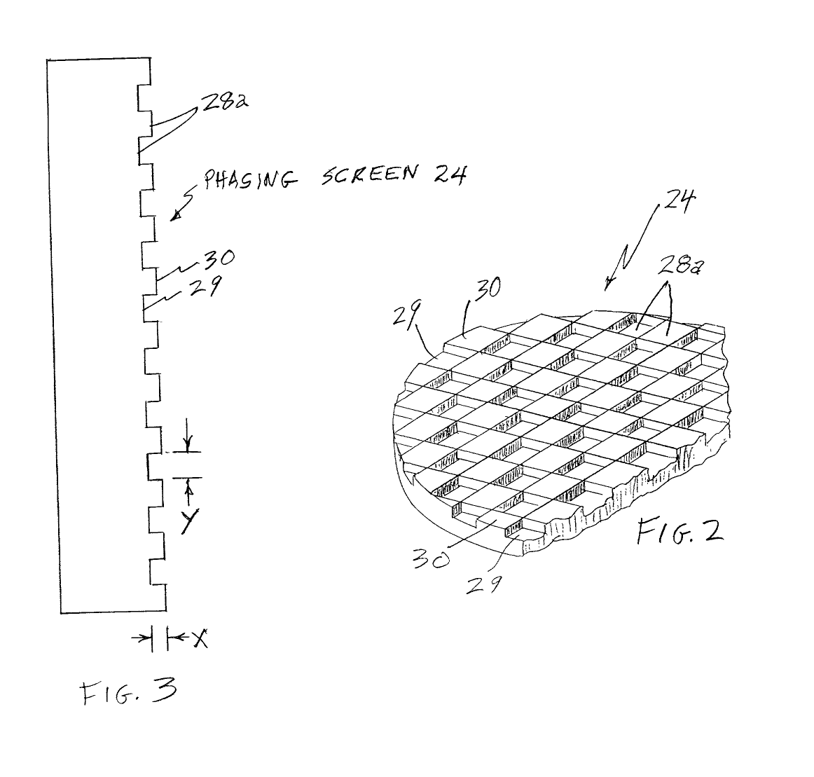

In FIG. 2, the phasing screen 24 has a plurality of discontinuities 28a between a proximal surface 29 and a distal surface 30. As shown in FIG. 3, the dimensional difference between the surfaces 29, 30 is defined herein as x, and the extent of each element of one surface or the other is defined herein as y.

The intensity, I, of the illumination at the target retina is:

I=I₀e^{-(Δφ}^{_{R}}⁾^{²} Eqn. 1

where I₀= the initial intensity, in the absence of phase distortion

Δφ_{R}= the RMS phase change between elements of light passing through long segments of the phasing screen and elements of light passing through short segments of the phasing screen.

$${Δφ}_{R} = {\frac{2 π}{{λ}_{e}} [ \frac{{\int }_{0}^{y} {[ μ ( x - {x}_{a} ) ]}^{2} ⅆ {y}^{′}}{{\int }_{0}^{y} ⅆ {y}^{′}} ]}^{1 / 2} \qquad \text{Eqn. 2}$$

Where: Δₑ= effective wavelength of white light≈25 microns

x= the difference in optical path length between the long and short segments of the phasing lens (FIG. 3)

xₐ= average value of x, =x/2

y= the periodicity (or nominal periodicity) of the phasing screen discontinuities (FIG. 3)

μ= index of refraction of the phasing screen, which may be between 1.3 for window glass up to about 1.6 for quartz

$${Δφ}_{R} = \frac{π μ x}{{λ}_{e}} \qquad \text{Eqn. 3}$$

Taking μ to be 1.3 and with x=1.6×10⁻³, the intensity at the focus is reduced

I=I₀e^{-(Δφ}^{_{R}}⁾²=I₀e^{-7.2}=I₀×10⁻³ Eqn. 4

Of course, dispersion values other than 10⁻³, such as 10⁻², 10⁻⁴, etc. may be used if desired. And, x may be as low as several microns, or some other dimension.

In order to have adequate light for anterior segment surgery, the dispersion of light at, say, the plane of the iris, should be small, which is achieved by proper choice of the Fresnel number of the phasing screen. The distance, D, to the near field/far field interface is related to the Fresnel number, F, as follows:

$$F = \frac{2 {π ( y / 2 )}^{2}}{{λ}_{e} D} \qquad \text{Eqn. 5}$$

If y is chosen to be ¼ of a centimeter, and using a Fresnel number of 1.4,

$$D = \frac{{π ( .25 )}^{2}}{( 2 ) 25 \times {10}^{- 4} ( 1.4 )} = 28 cm \qquad \text{Eqn. 6}$$

Therefore, the subject eye may be up to about 30 cm (1 foot) from the phasing screen without significant reduction in the illumination of the anterior segment surgical field. If greater distances are required, the illumination may be increased with a linear proportional increase of intensity at the cornea, and a corresponding but still non-harmful intensity on the retina.

In the prior art, a small spot of light is centered within the fovea, which is larger than the spot, to center a replacement cornea. With the invention, the fovea is centered within a spot of light which is much larger than the fovea.

In FIGS. 3 and 4, the discontinuities in the mirror 25 are shown as being square and flat. However, they may be of any shape and may be rounded. That is, the maxima and minima could be other than plane surfaces, having any sort of curvilinear or polygonal shapes and surfaces.

As described hereinbefore, use of the phasing screen for the present invention can reduce the intensity of illumination at the retina by 1000 or more fold, which is sufficient to prevent there being damage to the fovea or the retina even if the exposure extends for 30 minutes or more. Therefore, with light dispersion of the invention in use, there is never any need to move the illumination away from the fovea insofar as avoiding photochemical damage to the retina is concerned; the invention prevents such damage.

In further accord with the invention, the dispersion may be altered selectively to change the size of the spot focused on the cornea. In one embodiment, the phasing screen may be mounted on a pivot 44 so that after preliminary alignment of a cornea with the fovea, the fovea being centered within the dispersed spot at the cornea which is provided by the invention, the phasing screen may be pivoted out of the path of light from the source so as to momentarily provide a spot of light (as in the prior art) for final positioning of the cornea, after which the lens 24 may be repositioned in the path of light, so as to ensure alignment of the cornea without any opportunity for causing phototoxic lesions on the retina. In another embodiment, the index of refraction of the phasing screen may be variable in response to an electric field, such as by using a Kerr cell as the phasing screen, or by making the phasing screen out of suitably doped optical plastics.

The invention is shown implemented by means of a mirror which turns the illumination to make it generally coaxial with the visual axis of the microscope. However, the illumination may be brought to the field of view by means of optical fibers, if desired. In fact, the invention may readily be implemented in a surgical microscope employing optical fibers for the visual path as well.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

I claim:

1. An illuminated microscope comprising:
microscope optics;
eye pieces aligned along an optical axis with said microscope optics so as to visually present a field of view to an operator looking through the eye pieces;
a light source for illuminating said field of view, said light source being disposed to provide light along a path at an angle to said optical axis;
a phasing screen, elements of light passing through certain portions of said phasing screen emerging from said phasing screen with phase that differs from elements of light passing through other portions of said phasing screen, said phasing screen being disposed between said light source and said field of view, thereby to disperse light sufficiently to reduce the intensity of light by at least one hundred times on a subject within a far field beyond said field of view.

2. A microscope according to claim 1 wherein:
said phasing screen has a light entry surface and a light exit surface, at least one of said surfaces having discontinuities therein whereby elements of light passing through certain portions of said phasing screen will emerge from said phasing screen with phase that differs from elements of light passing through other portions of said phasing screen.

3. A microscope according to claim 1 wherein
said phasing screen is disposed between said light source and said microscope optics.

4. A microscope according to claim 1 wherein:
the degree of phase difference and therefore the amount of dispersion is selectable.

5. A microscope according to claim 4 wherein:
said phasing screen may be selectively moved out from being between said light source and said field of view.

6. An illuminated microscope comprising:
microscope optics;
eye pieces aligned along an optical axis with said microscope optics so as to visually present a field of view to an operator looking through the eye pieces;
a light source for illuminating said field of view; and
means for providing, in the illumination provided by said light source, spatially recurring phase changes that produce optical distortion which defocuses the light sufficiently to reduce the intensity of illumination in the far field by at least 100 times from what it would be without said optical distortion.

7. A microscope according to claim 6 wherein said means for providing comprises:
means for providing, in the illumination provided by said light source, spatially recurring phase changes that produce optical distortion which defocuses the light sufficiently to reduce the intensity of illumination in the far field by at least 1000 times from what it would be without said optical distortion.

8. A method of operating an illuminated microscope having microscope optics, eye pieces aligned along an optical axis with said microscope optics so as to visually present a field of view to an operator looking through the eye pieces, a light source for illuminating said field of view, which method comprises:
providing spatially recurring phase changes in the illumination provided by said light source that produce optical distortion which defocuses the light sufficiently to reduce the intensity of illumination in the far field by at least 100 times from what it would be without said optical distortion.

9. A method according to claim 8 wherein said providing step comprises:
providing spatially recurring phase changes in the illumination provided by said light source that produce optical distortion which defocuses the light sufficiently to reduce the intensity of illumination in the far field by at least 1000 times from what it would be without said optical distortion.

10. A method according to claim 8 further comprising:
selectively adjusting the degree of phase difference and therefore the amount of dispersion.

11. A method according to claim 10 wherein said step of selectively adjusting comprises eliminating the phase difference.

12. A method of operating an ophthalmic, illuminated surgical microscope having microscope optics, eye pieces aligned along an optical axis with said microscope optics so as to visually present a field of view to an operator looking through the eye pieces, and a light source for illuminating said field of view, which method comprises:
providing, in the illumination provided by said light source, spatially recurring phase changes that produce optical distortion which defocuses the light sufficiently to reduce the intensity of illumination on the retina by at least 100 times from what it would be without said optical distortion.

13. A method according to claim 12 wherein said providing step comprises:
providing spatially recurring phase changes in the illumination provided by said light source that produce optical distortion which defocuses the light sufficiently to reduce the intensity of illumination in the far field by at least 1000 times from what it would be without said optical distortion.
